(19) United States
(12) Patent Application Publication
(10) Pub. No.: US 2006/0192985 A1
(43) Pub. Date: Aug. 31, 2006

(54) Printing system

(75) Inventor: Zhongming Shen, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA SYSTEMS LABORATORY, INC.

(21) Appl. No.: 11/066,226

(22) Filed: Feb. 25, 2005

(51) Int. Cl. G06F 15/00

(52) U.S. Cl. 358/1.13; 358/1.15

(57) ABSTRACT

The present application relates to a printing system by which the users can notice the discrepancy between printer setting and user's intention before printing and recover such discrepancy easily even if such discrepancy occurs.

### FIELD

The present invention relates to a system for printing.

### INTRODUCTION

By utilizing a printing system including a printer and a personal computer (PC), users can print documents which the users produce by their PC.

However, utilizing such printing system exhibits certain drawback. When certain user tries to print documents by a printer, the printer's physical and current settings may mismatch printer driver's configuration. Or, in some cases, the printer's status does not comply the printer driver's setting. For example, a printer is loaded with A4 paper, however, the printer driver may be actually configured with letter paper. When the users print the documents with the printer driver's settings, the printer driver just simply prints out to the printer without alerting the user that there is discrepancy between the intension of the user and actual physical settings. And the users might get frustrated with what is going on.

Therefore, it is desirable that the users can notice the discrepancy between printer setting and user's intention before printing and recover such discrepancy easily even if such discrepancy occurs.

### SUMMARY

According to various embodiments, the present teachings can provide a printing system. The printing system can comprise a printer driver which configures print job parameter, produces a print job based on the print job parameter and document data, and sends the print job. The printing system can comprise a detecting portion which detects printer condition. The printing system can comprise a comparing portion which compares the printer condition detected by the detecting portion with the print job parameter configured by the printer driver. The printing system can comprise a displaying portion which displays various information. The printing system can comprise a printing portion which prints based on the print job produced and sent by the printer driver after receiving the print job from the printer driver. The comparing portion can compare the printer condition with the print job parameter before the printer driver sends the print job to the printing portion. If the comparing portion detects a discrepancy between the printer condition and the print job parameter, the printer driver can produce an alerting message based on the result of the comparing portion and the displaying portion displays the alerting message.

### BRIEF DESCRIPTION OF THE DRAWINGS

FIG. 1 illustrates a figure of relationship among application software, printer driver and print spooler, according to certain embodiments.

FIG. 2 illustrates a block diagram of a printing system comprising a PC and a printer, according to certain embodiments.

### DESCRIPTION OF CERTAIN EMBODIMENTS

System and Apparatus

In certain embodiments, a printing system can comprise one or several PC (s) and/or server(s). In certain embodiments, the printing system can comprise one or several printer(s). In certain embodiments, the printing system can comprise network which connects the PC and/or the server with the printer.

In certain embodiments, the PC can comprise at least one of a hard disk, a memory, a network connecting portion, a displaying portion, a data input portion and a central processing unit (CPU) or a micro processing unit (MPU). Examples of the network connecting portion consistent with certain embodiments of the invention include, but are not limited to, a local area network (LAN) adapter, a modem and a network card. Examples of the displaying portion consistent with certain embodiments of the invention include, but are not limited to, a liquid crystal display (LCD), a Braun tube, a cathode ray tube (CRT) and a plasma display panel. Examples of the data input portion consistent with certain embodiments of the invention include, but are not limited to, a keyboard, a mouse, a push button and a touch panel.

In certain embodiments, application software can be installed into the PC. In certain embodiments, the application software can be used to produce document data (including document, drawing, table, picture and/or photo and the like) which can be printed by the printer. Examples of the application software consistent with certain embodiments of the invention include, but are not limited to, word processor software (e.g., Microsoft Word™ etc.), image processing software (e.g., Adobe Photoshop™ etc.), spread sheet software (e.g., Microsoft Exce™ etc) and viewer software (e.g., Acrobat Reader™ etc.).

In certain embodiments, software of printer driver can be installed into the PC. In certain embodiments, the printer driver can control the printer connected with the PC in which the printer driver is installed. In certain embodiments, the printer driver can configure print job parameter generally corresponding to user's operation. In certain embodiments, the printer driver can configure the print job parameter automatically.

In certain embodiments, the print job parameter can be condition(s) of printing configured by the printer driver. Examples of the print job parameter consistent with certain embodiments of the invention include, but are not limited to, printer name for printing, tray name or number of the printer, size of print medium (e.g., Letter, Legal, A4, A3, B5, B4 and the like), kind of print medium (e.g., normal paper, special paper, postcard, OHP film and the like), duplex print or simplex print, number of copies, page range, layout (orientation. page order and the like) and kind of printer.

In certain embodiments, the printer driver can produce a print job based on the document data produced by the application software of the PC connected with the printer or another PC and the print job parameter configured by the printer driver. In certain embodiments, the print job can include the document data and the print job parameter. In certain embodiments, the printer driver can control transfer of the print job from the PC to the printer.

In certain embodiments, software of print spooler can be installed into the PC. In certain embodiments, the print spooler can conduct management process of printing, that is a spooler process. Such spooler process can involve retrieving location of correct printer driver, loading that printer driver, spooling high-level function calls into the print job, scheduling print job for printing, and so on. In certain embodiments, the software of the print spooler can start at system starting time and is available until either service is stopped or operating system (OS) shutdown. In certain embodiments, the application software and/or the printer driver can conduct the spooler process with the print spooler.

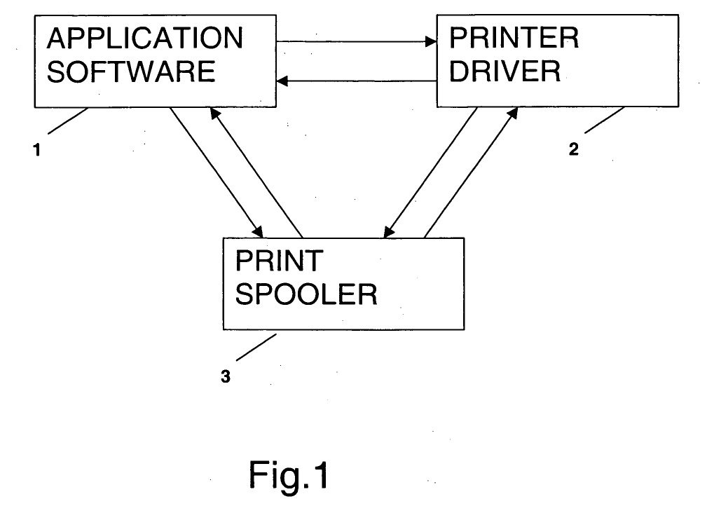

In certain embodiments, as illustrated in FIG. 1, relationship among the application software, the printer driver and the print spooler can be shown. In certain embodiments, application software 1 can produce the document data and send the document data to the printer driver 2. In certain embodiments, the printer driver 2 can produce the print job and send the print job to the print spooler 3. In certain embodiments. the printer driver 2 can provide printer condition to the application software 1. In certain embodiments, the print spooler 3 can store the print job sent from the printer driver. In certain embodiments, the print spooler 3 can send the print job to the printer driver 2 to send the print job from the PC to the printer. In certain embodiments, the communication between the application software 1 and the print spooler 3 can deal with general job information (e.g., printer condition, print job status, port selection and the like).

Examples of the printer consistent with certain embodiments of the invention include, but are not limited to, a laser beam printer, a multi function printer including copying function (MFP), an ink jet printer, a thermal printer (e.g., dye sublimation printers) and a silver halide printer. In certain embodiments, the printer can comprise at least one of a printing portion, a CPU or a MPU, a memory, a displaying portion, a data input portion and a network connecting portion. Examples of the network connecting portion, the displaying portion and the data input portion consistent with certain embodiments of the invention include, but not limited to, examples described in the above.

Examples of the network consistent with certain embodiments of the invention include, but are not limited to, an internet, a LAN and a wide area network (WAN). The printer and the PC can be connected with a wire or be connected with wireless by using radio frequency (RF) and/or infrared (IR) transmission.

In certain embodiments, at least one of the printing system can comprise a printer driver, a detecting portion, a comparing portion, a displaying portion and a printing portion. In certain embodiments, the printer driver can configure the print job parameter, produce the print job based on the print job parameter and the document data and send the print job. In certain embodiments, the detecting portion can detect printer condition. In certain embodiments, the comparing portion can compare the printer condition detected by the detecting portion with the print job parameter configured by the printer driver. In certain embodiments, the displaying portion can display various information. In certain embodiments, the printing portion can print based on the print job produced and sent by the printer driver after receiving the print job from the printer driver. In certain embodiments, the comparing portion can compare the printer condition with the print job parameter before the printer driver sends the print job to the printing portion. In certain embodiments, the printer driver can produce an alerting message based on the result of the comparing portion and the displaying portion displays the alerting message if the comparing portion detects a discrepancy between the printer condition and the print job parameter.

In certain embodiments, the printing portion can print based on the print job produced and sent by the printer driver after receiving the print job from the printer driver. In certain embodiments, the printing portion can print based on the printer condition. Examples of the printing portion consistent with certain embodiments of the invention include, but are not limited to, a printing unit of the printer and a printing engine of the printer.

In certain embodiments, the displaying portion can display various information. If the printing system comprises the PC, the displaying portion can be the displaying portion of the PC. If the printing system comprises the printer, the displaying portion can be the displaying portion of the printer. Examples of the displaying portion consistent with certain embodiments of the invention include, but are not limited to, examples described in the above.

In certain embodiments, the printing system can comprise the data input portion. In certain embodiments, the user can input certain data, instruction and/or operation from the data input portion. Examples of the data input portion consistent with certain embodiments of the invention include, but are not limited to, examples described in the above. In certain embodiments, the PC can comprise the data input portion. In certain embodiments, the printer can comprise the data input portion.

In certain embodiments, the printing system can comprise a network connecting portion. In certain embodiments, the network connecting portion can transfer the print job from the printer driver to the printing portion or from the PC to the printer or vice versa. Examples of the network connecting portion consistent with certain embodiments of the invention include, but not limited to, a local area network (LAN) adapter, a modem and a network card. In certain embodiments, the PC can comprise the network connecting portion. In certain embodiments, the printer can comprise the network connecting portion.

In certain embodiments, the printer driver can configure the print job parameter and produce the print job based on the print job parameter and the document data and send the print job to the printing portion. Regarding the print job parameter, the document data and the print job, they are explained in the above. Examples of the printer driver consistent with certain embodiments of the invention include, but are not limited to, a CPU or a MPU, a hard disk and a memory of the PC with the software of the printer driver. In certain embodiments, the printer driver can produce an alerting message. Regarding the alerting message and produce of the alerting message by the printer driver, it is described later. In certain embodiments, the software for the printer driver can be divided to several software. In certain embodiments, the software for producing the alerting message, detecting the printer condition and/or comparing the printer condition with the print job parameter can be separated from other software of the printer driver. The software for producing the alerting message, detecting the printer condition and/or comparing the printer condition with the print job parameter which is separated from other software of the printer driver can be deemed as software of the printer driver.

In certain embodiments, the detecting portion can detect the printer condition. In certain embodiments, the printer condition can be condition of the printing portion and/or the condition of the printer. Examples of the printer condition consistent with certain embodiments of the invention include, but are not limited to, name of the printer, name or number of the tray of the printer, kind of printing medium set in the printer, size of printing medium set in the printer, kind and/or size of printing medium set in the tray of the printer, whether there is printing medium in the tray which the user designates or not, whether there is a tray which the user designates in the printer or not, whether the printer is able to do duplex-printing or not, whether there is a printing medium in the printer or not, whether the printer connects with the PC or not, whether the printer is turned on or not, whether the printer is jammed by a printing medium or not, whether there is capacity of memory for printing or not and the like. Examples of the detecting portion consistent with certain embodiments of the invention include, but are not limited to, a CPU or a MPU and the hard disk and the memory of the PC with the software of the printer driver and a CPU, a MPU or an IC and the memory of the printer with the software installed in the printer. In certain embodiments, the detecting portion can detect the number of papers set in the printing portion.

In certain embodiments, the detecting portion (e.g., the CPU of the PC with the software of the printer driver) can ask the printer condition to the printing portion or the printer. In certain embodiments, the detecting portion can ask the printer condition by sending a query command to the printing portion or the printer. In certain embodiments, the query command can be produced according to Printer Job Language (PJL) command. In certain embodiments, the detecting portion can ask the printer condition to the printing portion or the printer periodically and automatically. In certain embodiments, the detecting portion can ask the printer condition to the printing portion or the printer after or when the print job parameter is configured by the printer driver. In certain embodiments, based on the query command from a part of the detecting portion (e.g., the CPU of the PC with the software of the printer driver), other part of the detecting portion (e.g., the CPU of the printer) can start to detect the printer condition. In certain embodiments, after the part of the detecting portion (e.g., the CPU of the printer) detects the printer condition of the printing portion or the printer, response signal about the detected printer condition can be sent from the part of the detecting portion (e.g., the CPU of the printer) to the other part of the detecting portion (e.g., the CPU of the PC with the software of the printer driver). In certain embodiments, by receiving the response signal of the printer condition by the part of the detecting portion (e.g., the CPU of the PC with the software of the printer driver), the detecting portion can finish the detecting of the printer condition. In certain embodiments, PC might not send the query command to the printer, the detecting portion (e.g., the CPU of the printer) can detect the printer condition and the printer can send information of the printer condition automatically and spontaneously, when the printer condition changes.

In the certain embodiments, the detecting portion can detect the printer condition before the printer driver sends the print job to the printing portion. In certain embodiments, the detecting portion can detect the printer condition after the instruction of starting print is input and before the printer driver sends the print job to the printing portion. In certain embodiments, the detecting portion can detect the printer condition before the printer driver produces the print job. In certain embodiments, the detecting portion can detect the printer condition just after the user selects the kind of printer or at least one of any other print job parameter. In certain embodiments, the detecting portion can detect the printer condition periodically and automatically.

In certain embodiments, the comparing portion can compare the printer condition detected by the detecting portion with the print job parameter configured by the printer driver. Examples of the comparing portion consistent with certain embodiments of the invention include, but are not limited to, a CPU or a MPU and the memory of the PC with the software of the printer driver, and a CPU, a MPU or an IC and the memory of the printer. In certain embodiments, the discrepancy between the print job parameter and the printer condition can be detected from the result of the comparison by the comparing portion. Examples of such discrepancy between the print job parameter and the printer condition consistent with certain embodiments of the invention include, but are not limited to, 1) although certain printer being configured as the print job parameter, the configured printer is turning off, 2) although certain printer being configured as the print job parameter, there is no printer connected to the PC, 3) although certain printer being configured as the print job parameter, only other printers, not the configured printer, are connected to the PC, 4) although certain printer being configured as the print job parameter, there is no paper in the printer, 5) although certain printer, number of copies and page range being configured as the print job parameter, the number of papers in the printer is not enough for the printing, 6) although certain printer being configured as the print job parameter, the printer is jamming, 7) although certain printer being configured as the print job parameter, the memory of the printer is low, 8) although certain printer and duplex-print being configured as the print job parameter, the printer can do only simplex-printing and cannot do duplex-printing, 9) although certain printer and size of printing paper being configured as the print job parameter, the printer does not include the size of the printing paper, 10) although certain tray of the printer being configured as the print job parameter, the printer does not have the tray, 11) although certain tray of the printer being configured as the print job parameter, there is no printing medium in the tray and the like. In certain embodiments, if the comparing portion does not detect any discrepancy between the printer condition and the print job parameter, the comparing portion can send the result to the printer driver. Then, the printer driver can produce the print job based on the document data and the print job parameter and can send the print job to the printing portion, and the printing portion can print based on the print job.

In the certain embodiments, the comparing portion can compare the printer condition and the print job parameter before the printer driver sends the print job to the printing portion. In certain embodiments, the comparing portion can compare the printer condition and the print job parameter after the instruction of starting print is input and before the printer driver sends the print job to the printing portion. In certain embodiments, the comparing portion can compare the printer condition and the print job before the printer driver produces the print job. In certain embodiments, the comparing portion can compare the printer condition and the print job parameter just after the user selects the kind of printer, the paper size or at least one of any other print job parameter.

In certain embodiments, if the comparing portion detects the discrepancy between the printer condition and the print job parameter, the printer driver can produce an alerting message based on the result of the comparing portion and the displaying portion can display the alerting message. In certain embodiments, the printer driver can produce the alerting message based on the discrepancy detected by the comparing portion.

In certain embodiments, the alerting message can be produced and displayed before the printer driver sends the print job to the printing portion. In certain embodiments, the alerting message can be produced and displayed after the instruction of starting print is input and before the printer driver sends the print job to the printing portion. In certain embodiments, the alerting message can be produced and displayed before the printer driver produces the print job. In certain embodiments, the alerting message can be produced and displayed just after the user selects the kind of printer or at least one of any other print job parameter

In certain embodiments, the alerting message can include information only about there is the discrepancy between the printer condition and the print job parameter. For instance, the following is one example of such alerting message: “ALERTING MESSAGE. YOUR DESIGNATED PRINTING CONDITION IS INCONSISTENT WITH CURRENT CONDITION OF THE PRINTER” and the like. In certain embodiments, the alerting message can include information about contents of the discrepancy. For instance, the following is one example of such alerting message: “ALERTING MESSAGE. YOUR DESIGNATED PRINTING CONDITION IS INCONSISTENT WITH CURRENT CONDITION OF THE PRINTER. THE PAPER SIZE DESIGNATED IS NOT STORED IN THE PRINTER” and the like. In certain embodiments, the alerting message can be a warning sign (e.g., only a vivid color exclamation point, only a red cross, only changing color of the portion which displays the print job parameter being inconsistent with the printer condition and the like). In certain embodiments, the alerting message can be displayed by the displaying portion of the PC. In certain embodiments, the alerting message can be displayed by the displaying portion of the printer.

In certain embodiments, the printing system can comprise a data storing portion. Examples of the data storing portion consistent with certain embodiments of the invention include, but are not limited to, a hard disk and a memory (e.g., a random access memory(RAM) including NVRAM, M RAM, P RAM, Fe RAM, Flash RAM, and a read only memory(ROM)). In certain embodiments, the data storing portion can store several formats or samples of sentences for the alerting message in advance. In certain embodiments, the printer driver can produce the alerting message based on the format or the sample of the sentence stored in the data storing portion. In certain embodiments, the printer driver can select the format or the sample of the sentence of the alerting message stored in the data storing portion based on the result of the detection by the detecting portion and the comparison by the comparing portion.

In certain embodiments, after the alerting message is displayed, instruction of next operation to the printing system can be input from the data input portion by the user.

In certain embodiments, the instruction can be that despite the alerting message the printing portion should print based on the printer condition and the document data of the print job. Then, the printer driver can produce the print job based on the document data and the printer condition. And, the printer driver can send the print job to the printing portion and the printing portion can print based on the print job. In certain embodiments, if the user instructs from the data input portion that despite the alerting message the printing portion should print based on the printer condition and there are several choices of the printer conditions, the printer driver can automatically select one of the printer conditions which is the closest to the print job parameter. Then, the printer driver can produce the print job based on the document data and the selected printer condition. And, the printer driver can send the print job to the printing portion and the printing portion can print based on the print job. In certain embodiments, the detecting portion or the comparing portion can judge what printer condition is the closest to the print job parameter. In certain embodiments, the data storing section can store the information about which condition is closer to certain condition than other condition. In certain embodiments, the detecting portion or the comparing portion can judge what printer condition is the closest to the print job parameter based on the information stored in the data storing section. In certain embodiments, the printer driver can automatically select one of the printer conditions randomly.

In certain embodiments, the instruction can be that the print job parameter configured by the printer driver should be amended based on the data input by the data input portion. In certain embodiments, the printer driver can produce a resolution message in addition to the alerting message and the displaying portion can display the resolution message. In certain embodiments, the resolution message can be integrated with the alerting message in one message box. In certain embodiments, the resolution message can be separated with the alerting message. In certain embodiments, the resolution message can include information about how to resolve the discrepancy on the basis of the result of detecting by the detecting portion and comparing by the comparing portion. For instance, the resolution message can be “LOAD PAPER OF LETTER SIZE TO THE PRINTER 5” or “TURN ON THE PRINTER 3” and so on. In certain embodiments, the resolution message can include information about what parameter should be amended in the printer job parameter based on the discrepancy. In certain embodiments, the resolution message can include information about what condition should be amended in the printer condition based on the discrepancy. In certain embodiments, the print job parameter can be amended based on the data input from the data input portion by the user generally corresponding to the resolution message. In certain embodiments, after the print job parameter is amended, the comparing portion can compare the new print job parameter with the printer condition. If the comparing portion does not find any discrepancy between the new print job parameter and the printer condition, the comparing portion can send such result to the printer driver. Then, the printer driver can produce the print job and send the print job to the printing portion. And, the printing portion can print based on the print job. If the comparing portion finds any discrepancy between the print job parameter and the new printer condition, the printer driver can produce the alerting message.

In certain embodiments, the data storing portion can store several formats or samples of sentences for the resolution message in advance. In certain embodiments, the printer driver can produce the resolution message based on the format or the sample of the sentence stored in the data storing portion. In certain embodiments, the printer driver can select the format or the sample of the sentence of the resolution message stored in the data storing portion based on the result of the detection by the detecting portion and the comparison by the comparing portion.

In certain embodiments, the instruction can be that the print job should be cancelled or should not be produced, and the printing portion should not print. In certain embodiments, after displaying the alerting message, the printer driver can automatically cancel the print job or stop producing the print job.

In certain embodiments, after displaying the alerting message, the user can alter the printer condition. After the altering the printer condition, the user can instruct to start printing generally corresponding to the print job parameter from the data input portion. In certain embodiments, after instructing to start printing, the detecting portion can detect the altered printer condition again and the comparing portion can compare the print job parameter with the new printer condition. If the comparing portion does not find any discrepancy between the print job parameter and the new printer condition, the comparing portion can send such result to the printer driver. Then, the printer driver can produce the print job and send the print job to the printing portion. And, the printing portion can print based on the print job. If the comparing portion finds any discrepancy between the print job parameter and the new printer condition, the printer driver can produce the alerting message.

In certain embodiments, after displaying the alerting message, the several possible instructions among the above examples of the instruction can be displayed as the resolution messages on the displaying portion, then the user can select the preferable instruction from the data input section.

In certain embodiments, the software of the printer driver can be installed in the PC connected with the printer. The software of the printer driver can be installed into conventional printing system comprising the PC and the printer.

In certain embodiments, the software of the printer driver can be recorded onto a removable data recording medium. Examples of the removable data recording medium include, but are not limited to, digital memory cards, compact discs (e.g., CD-R, CD-RW, etc.), and digital versatile discs (e.g., DVD-R, DVD-RW, DVD+RW, etc.). Various types of digital memory cards compatible with certain embodiments of the invention include, but are not limited to, secure digital (SD) memory cards, Compact Flash™, Smart Media™, Memory Stick™, and the like.

In certain embodiments, the software of the printer driver can be delivered through the network (e.g., LAN, WAN, internet and so on).

### EXAMPLE

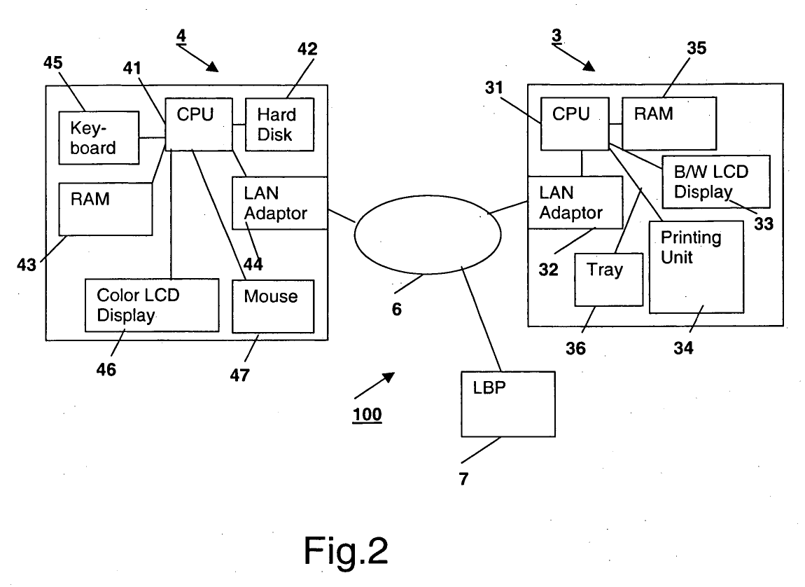

In certain embodiments, as illustrated in FIG. 2, the printing system 100 can comprise a PC 4, a laser beam printer (LBP) 3, a second LBP 7 and a LAN 6 connecting the PC 4 with the LBP 3.

In certain embodiments, as illustrated in FIG. 2, the PC 4 can comprise a printer driver (e.g., a CPU 41, a hard disk 42 and a RAM 43 with software of the printer driver installed in the PC 4), a print spooler (e.g., the CPU 41, the hard disk 42 and the RAM 43 with software of print spooler installed in the PC 4), a detecting portion (e.g., the CPU 41, a hard disk 42 and a RAM 43 with software of the printer driver installed in the PC 4), a comparing portion (e.g., the CPU 41, a hard disk 42 and a RAM 43 with software of the printer driver installed in the PC 4), a displaying portion (e.g., a color LCD display 46), a network connecting portion (e.g., a LAN adaptor 44), a data storing portion (e.g., the hard disk 42) and a data input portion (e.g., a keyboard 45 and a mouse 47). In certain embodiments, application software (e.g., Microsoft Word etc.), software of the printer driver and software of the print spooler can be installed in the PC 4.

In certain embodiments, the LBP 3 can comprise a printing portion (e.g., a printing unit 34), a detecting portion (e.g., a CPU 31), a displaying portion (e.g., a black and white LCD display 33), a RAM 35, a network connecting portion (e.g., a LAN adaptor 32) and a paper tray 36.

In certain embodiments, the LBP 3 can comprise two paper trays 36. One of the paper trays 36 can store letter size paper. The other paper tray 36 can store legal size paper. Each paper tray 36 can store 200 sheets of paper. In certain embodiments, the LBP 3 can print only normal paper. In certain embodiments, the LBP 3 can conduct only simplex printing and might not conduct duplex printing. For instance, the printer condition of the LBP 3 is as follows.

Power: ON, Connection: Connecting with the PC 4, Paper: Normal Paper, Paper Size and Number of Sheets: Letter 10 sheets, Legal 10 sheets,

(MAX, 200 sheets)

Duplex/Simplex: Only Simplex.

In certain embodiments, the user can produce the document data by using application software such as Microsoft Word and by inputting data from the keyboard 45 or the mouse 47 to the PC 4. In certain embodiments, the document data can be read from the removable data recording medium or be sent from other PC via network.

In certain embodiments, after producing or obtaining the document data, according to the printer driver software, the CPU 41 can configure print job parameter generally corresponding to the user's instruction input from the keyboard 45 or the mouse 47. In certain embodiments, if the user does not designate one or various print job parameter, the CPU 41 can automatically configure the print job parameter according to the printer driver software. For instance, the user can designate the followings as the print job parameter.

Printer: LBP 3, Paper: Normal Paper, Paper Size : A4,

Duplex/Simplex: Duplex, Number of Copies: 5 copies, Number of Pages: 2 page.

In certain embodiments, a printing start button can be displayed on the color LCD display 46. The user can click the printing start button by utilizing the keyboard 45 or the mouse 47 to start printing based on the document data.

In certain embodiments, after the user clicks the printing start button and before the printer driver produces the print job, the CPU 41 of the PC 4 as the part of the detecting portion can send query command to the CPU 31 of the LBP 3 as the part of the detecting portion through the LAN adaptor 44, the LAN adaptor 32 and the LAN 6. In certain embodiments, based on the query command sent from the CPU 41 of the PC 4, the CPU 31 can start detecting the printer condition. In certain embodiments, the CPU 31 can detect the printer condition (e.g., power: on, connection: connecting with the PC 4, paper: normal paper, paper size and number of sheets: Letter 10 sheets, Legal 10 sheets, duplex/simplex: only simplex) of the LBP 3. After the CPU 31 detects the printer condition of the LBP 3, the CPU 31 can send the response signal including the information of the printer condition to the CPU 41 through the LAN adaptor 44 the LAN adaptor 32 and the LAN 6. Then, the CPU 41 can obtain the information of the printer condition of the LBP 3.

In certain embodiments, after the CPU 41 receives the information of the printer condition of the LBP 3, the CPU 41 of the PC 4 as the comparing portion can compare the printer condition with the print job parameter. For instance, the CPU 41 can compare the printer condition with the print job parameter as described in the Table. 1.

TABLE 1

| | Printer Condition | Print Job Parameter |
|---|---|---|
| Printer | LBP 3 | LBP 3 |
| Power | ON | (ON) |
| Connection | Connecting with LBP 3 | (Connecting with LBP 3) |
| Paper | Normal Paper | Normal Paper |
| Paper Size | Only Letter or Legal | A4 |
| Duplex of Simplex | Only Simplex | Duplex |
| Number of Papers | 10 sheets Legal and 10 | 5 sheets by Duplex (or |
| | sheets Letter | 10 sheets by Simplex) |

In the column of “Print Job Parameter” of the Table. 1, power and connection are in parenthesis, because the print job parameter can include such parameter inherently although the print job parameter configured by the printer driver expressly does not include such parameter.

In certain embodiments, if the CPU 41 does not find any discrepancy between the printer condition and the print job parameter, the CPU 41 can produce the print job based on the document data and the print job parameter according to the printer driver software and send the print job to the LBP 3 according to the printer driver software through the LAN adaptor 44, the LAN adaptor 32 and the LAN 6. Then, the printing unit 34 of the LBP 3 can print based on the print job under the control of the CPU 31.

In certain embodiments, the discrepancy between the print job parameter and the printer condition can be detected from the result of the comparison by the CPU 41 as the comparing portion. For instance, as described in the Table. 1, the discrepancy between the print job parameter and the printer condition are the discrepancy of the paper size and the discrepancy of the duplex or simplex. Therefore, the CPU 41 can detect the discrepancy between the printer condition and the print job parameter.

In certain embodiments, if the CPU 41 detects the discrepancy between the printer condition and the print job parameter, the CPU 41 can produce an alerting message according to the printer driver software based on the contents of the discrepancy. In certain embodiments, the hard disk 42 can store several formats of sentence for the alerting message in advance. In certain embodiments, each format of sentence for the alerting message can include information about for what kind of discrepancy this format can be used. In certain embodiments, the CPU 41 can select the format for the alerting message based on the contents of the discrepancy. For instance, the hard disk 41 can store the following formats of sentences for the alerting message and information about for what kind of discrepancy each format can be used.

“YOUR DESIGNATING PRINT JOB PARAMETER IS NOT APPROPRIATE FOR THE PRINTER “X”.” (This sentence can be used for any alerting message.)

THIS PRINTER CAN PRINT ONLY “X” SIZE, BUT NOT “Y” SIZE. (This is for the discrepancy of paper size.)

THIS PRINTER CAN CONDUCT ONLY “X” PRINT, BUT NOT “X” PRINT. (This is for the discrepancy of simplex/duplex.)

THIS PRINTER DOES NOT TURN ON. (This is for the discrepancy of the printer switch.)

THIS PRINTER IS NOT CONNECTED. (This is for the discrepancy of the printer connection.)

THIS PRINTER DOES NOT STORE PAPER (This is for the discrepancy of the paper amount).” and the like.

For instance, as described in the Table 1., because the discrepancy is relating to the paper size and the duplex/simplex, the CPU 41 can select the format relating to the paper size and duplex/simplex from the several formats stored in the hard disk 8 and produce the following alerting message based on the format, the printer condition and the print job parameter. “YOUR DESIGNATING PRINT JOB PARAMETER IS NOT APPROPRIATE FOR THE PRINTER “3”.

THIS PRINTER CAN PRINT ONLY “LETTER” SIZE AND “LEGAL” SIZE, BUT NOT “A4” SIZE.

THIS PRINTER CAN CONDUCT ONLY “SIMPLEX “PRINT, BUT NOT “DUPLEX”.”

In certain embodiments, the alerting message produced by the CPU 41 according to the printer driver software can be displayed on the color LCD display 46.

In certain embodiments, the CPU 41 can produce a resolution message in addition to the above alerting message according to the printer driver software based on the result of the comparison. In certain embodiments, the hard disk 42 can store format of sentence for the following resolution message in advance and the CPU 41 can read the format for the resolution message based on the result of the comparison and produce the resolution message. For instance, the resolution message can be as follows.

“PLEASE SELECT ONE FROM FOLLOWING CHOICES.

CHOICE (1) PRINT BASED ON CURRENT PRINTER CONDITION

CHOICE (2) CHANGE PRINT JOB PARAMETER

CHOICE (3) STOP PRINTING”

In certain embodiments, the resolution message can be displayed on the color LCD display 46 and the button for each choice can be displayed at close position of each choice on the color LCD display 46 also. In certain embodiments, the user can select one of the choices by click of the button by the operation of the keyboard 45 or the mouse 47.

In certain embodiments, if the button of the choice (1) is clicked, the signal of the result of the selection can be sent to the CPU 41. After receiving the signal, the CPU 41 can automatically change one or several original print job parameter which causes the discrepancy to the new print job parameter so that the new print job parameter can be consistent with the printer condition and the printer condition which is the closest to the original print job parameter can be selected as the new print job parameter.

In certain embodiments, the hard disk 42 can store the information about what conditions are closer to certain condition than other condition and the CPU 41 can select the printer condition which is the closest to the original print job parameter. based on the information stored in the hard disk 42. For instance, A4 size of the original print job parameter can be changed into Letter size in the new print job parameter by the CPU 41 according to the printer driver software. Because the hard disk 42 can store the information that the A4 size is closer to the Letter size than the Legal size and CPU 41 can judge that A4 size is closer to Letter size than Legal size.

Duplex print of the original print job parameter can be changed into simplex print in the new print job parameter by the CPU 41 because the CPU 41 can judge that the LBP 3 cannot conduct the duplex print. In connection with the change from duplex to simplex., number of print sheets can be changed. For instance, 5 sheets print by duplex can be changed into 10 (5×2) sheets print by simplex. Because the LBP 3 stores 10 sheets of Letter size paper, there does not occur the discrepancy about the number of paper sheets even after the change of the number of print sheets. The new print job parameter can be decided automatically by the CPU 44 as follows.

Printer: LBP 3, Paper: Normal Paper, Paper Size: Letter,

Duplex/Simplex: Simplex, Number of Copies: 5 copies,

Number of Pages: 2 page.

In certain embodiments, after the new print job parameter is decided, the CPU 41 can produce the print job based on the document data and the new print job parameter according to the printer driver software. In certain embodiments, the CPU 41 can send the print job to the LBP 3 according to the printer driver software through the LAN adaptor 44, the LAN 6 and the LAN adaptor 32. In certain embodiments, the CPU 31 can control the printing unit 34 so that the printing unit 34 of the LBP 3 can print based on the print job.

In certain embodiments, if the button of the choice (2) is clicked, the signal of the result of the selection can be sent to the CPU 41. After receiving the signal, the CPU 41 can produce other resolution message to show the recommended condition of the new print job parameter to the user according to the printer driver software and the resolution message can be displayed on the color LCD display 46. In certain embodiments, the hard disk 42 can store several formats of sentence for the resolution message in advance. In certain embodiments, each format of sentence for the resolution message can include information about for what kind of discrepancy this format can be used. In certain embodiments, the CPU 41 can select the format for the resolution message based on the contents of the discrepancy. For instance, the hard disk 41 can store the following formats of sentences for the resolution message and information about for what kind of discrepancy each format can be used.

“IT IS RECOMMENDED THAT “X” SIZE WILL BE CHANGED TO “Y” SIZE. (This is for the discrepancy of paper size.)

IT IS RECOMMENDED THAT “X” PRINT WILL BE CHANGED TO “Y” PRINT. (This is for the discrepancy of simplex/duplex.)

IT IS RECOMMENDED THAT THIS PRINTER WILL BE TURNED ON. (This is for the discrepancy of the printer switch.)

IT IS RECOMMENDED THAT THIS PRINTER WILL BE CONNECTED. (This is for the discrepancy of the printer connection.)

IT IS RECOMMENDED THAT THE PAPER WILL BE LOADED INTO TRAY “X” OF THIS PRINTER. (This is for the discrepancy of the paper amount).”and the like.

For instance, as described in the Table 1., because the discrepancy is relating to the paper size and the duplex/simplex, the CPU 41 can select the format relating to the paper size and duplex/simplex from the several formats stored in the hard disk 8 and produce the following resolution message based on the format, the printer condition and the print job parameter.

“IT IS RECOMMENDED THAT “A4” SIZE WILL BE CHANGED TO “LEGAL” SIZE OR “LETTER” SIZE.

IT IS RECOMMENDED THAT “DUPLEX” PRINT WILL BE CHANGED TO “SIMPLEX” PRINT.”

In certain embodiments, after displaying the resolution message, the user can input instruction to change the print job parameter from the key board 45 or the mouse 47. In certain embodiments, the user can follow the resolution message and can change the print job parameter generally corresponding to the resolution message. In certain embodiments, the user can change the original print job parameter but might not follow the resolution message.

After the user changes the print job parameter, the user can click the printing start button from the keyboard 45 or the mouse 47 and the CPU 41 can detect the printer condition and compare the new print job parameter with the printer condition as stated in the above. If the CPU 41 finds no discrepancy between the new print job parameter and the printer condition, the CPU 41 can produce the print job based on the document data and the new print job parameter according to the printer driver software. In certain embodiments, the CPU 41 can send the print job to the LBP 3 according to the printer driver software through the LAN adaptor 44, the LAN 6 and the LAN adaptor 32. In certain embodiments, the CPU 31 can control the printing unit 34 so that the printing unit 34 of the LBP 3 can print based on the print job.

If the CPU 41 finds discrepancy between the new print job parameter and the printer condition, the CPU 41 can produce the alerting message according to the printer driver software and the alerting message can be displayed on the color LCD display 46.

In certain embodiments, if the button of choice (3) is clicked, the signal of the result of the selection can be sent to the CPU 41. After receiving the signal, the CPU 41 can stop further processing. Therefore, the CPU 41 does not produce and send the print job and the LBP 3 does not print.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A printing system, comprising:
a printer driver that configures print job parameter and produces a print job based on the print job parameter and document data, and sends the print job,
a detecting portion that detects printer condition,
a comparing portion that compares the printer condition detected by the detecting portion with the print job parameter configured by the printer driver,
a displaying portion that displays various information,
a printing portion that prints based on the print job-produced and sent by the printer driver after receiving the print job from the printer driver, and
wherein the comparing portion compares the printer condition with the print job parameter before the printer driver sends the print job to the printing portion, and
wherein the printer driver produces an alerting message based on the result of the comparing portion and the displaying portion displays the alerting message if the comparing portion detects a discrepancy between the printer condition and the print job parameter.

2. The printing system of claim 1, wherein the alerting message includes information about what contents of the discrepancy are.

3. The printing system of claim 1, wherein the comparing portion compares the printer condition with the print job parameter before the printer driver produces the print job.

4. The printing system of claim 3, wherein the printing system comprises plurality of printing portions, and
wherein the comparing portion compares the printer condition with the print job parameter just after one of the plurality of printing portions is selected as one of the print job parameter.

5. The printing system of claim 1, further comprising:
a data input portion from which an user inputs data or instruction, and
wherein instruction about next operation to the printing system is input by the data input portion after the alerting message is displayed.

6. The printing system of claim 5, wherein the instruction is that despite the alerting message the printing portion prints based on the printer condition and the document data of the print job

7. The printing system of claim 5, wherein the instruction is that the print job parameter configured by the printer driver is amended based on the data input by the data input portion.

8. The printing system of claim 7, wherein the printer driver produces resolution message which includes information about how to resolve the discrepancy if the comparing portion detects the discrepancy, and
wherein the displaying portion displays the resolution message, and the print condition is amended based on the data input by the data input portion corresponding to the resolution message.

9. The printing system of claim 5, wherein the instruction is that the print job is cancelled and the printing portion does not print.

10. The printing system of claim 1, wherein the printing system comprises a personal computer and a printer, and
wherein the personal computer comprises the displaying portion, and
wherein the displaying portion of the personal computer displays the alerting message if the comparing portion detects the discrepancy between the printer condition and the print job parameter.

11. The printing system of claim 1, wherein the printing system comprises a personal computer and a printer, and
wherein the printer comprises the displaying portion, and
wherein the displaying portion of the printer displays the alerting message if the comparing portion detects the discrepancy between the printer condition and the print job parameter.
